(19) United States
(12) Patent Application Publication
(10) Pub. No.: US 2011/0078761 A1
(43) Pub. Date: Mar. 31, 2011

(54) METHOD AND APPARATUS FOR EMBEDDING REQUESTS FOR CONTENT IN FEEDS

(75) Inventors: Juha Kaario, Tampere (FI); Jukka Saarinen, Helsinki (FI)

(73) Assignee: Nokia Corporation, Espoo (FI)

(21) Appl. No.: 12/567,503

(22) Filed: Sep. 25, 2009

(51) Int. Cl. G06F 15/16; G06F 21/00

(52) U.S. Cl. 726/3; 709/203

(57) ABSTRACT

An approach is provided for embedding requests for news inputs in web feeds to news input sources. A request for news input is received in conjunction with a web feed. The request includes filtering information for targeting news input sources. And, the web feed with the request for news input embedded in the web feed is caused at least in part to be transmitted to a news input source that satisfies the filtering information.

### BACKGROUND

Conventional content (e.g., news) outlets have limited resources, and therefore allocate a professional writer (or journalist) to all locations at all times in order to cover in real-time all news events as they unfold. Citizen news reporting is a growing global trend where, through blogging or other postings, citizen observers are able to quickly disseminate news information. The widespread use of mobile camera phones has created a large potential for the capturing and disseminating of such news information in real-time. However, while mobile phone technology has created a potential for the capturing and dissemination of such news information, there are significant hurdles for news outlets to effectively collect and filter through the information from such citizen news reporting so that news worthy information can be quickly collected and passed on to their consumers.

### SOME EXAMPLE EMBODIMENTS

Therefore, there is a need for an approach for embedding requests for news inputs in web feeds that can allow for targeting of news input sources.

According to one embodiment, a method comprises receiving a request for news input in conjunction with a web feed, wherein the request includes filtering information for targeting news input sources. The method further comprises causing at least in part transmitting of the web feed with the request for news input embedded in the web feed to a news input source that satisfies the filtering information.

According to another embodiment, an apparatus comprising at least one processor, and at least one memory including computer program code, the at least one memory and the computer program code configured to, with the at least one processor, cause the apparatus to receive a request for news input in conjunction with a web feed, wherein the request includes filtering information for targeting news input sources. The apparatus is also caused to at least in part transmit of the web feed with the request for news input embedded in the web feed to a news input source that satisfies the filtering information.

According to one embodiment, a method comprises causing at least in part transmitting of a request for a web feeds. The method further comprises receiving the web feed with a request for news input embedded in the web feed if the request for the web feed satisfies filtering information for targeting news input sources, which corresponds to the request for news input.

According to another embodiment, an apparatus comprising at least one processor, and at least one memory including computer program code, the at least one memory and the computer program code configured to, with the at least one processor, cause the apparatus to cause at least in part transmitting of a request for a web feeds. The apparatus is also caused to receive the web feed with a request for news input embedded in the web feed if the request for the web feed satisfies filtering information for targeting news input sources, which corresponds to the request for news input.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of embedding requests for news inputs in web feeds, according to one embodiment;

FIG. 2 is a diagram of the components of a service platform that embeds requests for news inputs in web feeds, according to one embodiment;

FIG. 3 is a diagram of the components of user equipment that receives embedded requests for news inputs in web feeds, according to one embodiment;

FIG. 4A is a flowchart of a process for registering requests for assignments from a new input source, according to one embodiment;

FIG. 4B is a flowchart of a process for requesting registration for assignments from a new input source, according to one embodiment;

FIG. 5 is a flowchart of a process for receiving and embedding requests for news inputs in web feeds, according to one embodiment;

FIG. 6 is a flowchart of a process for requesting web feeds and receiving embedded requests for news inputs in the web feed, according to one embodiment;

FIG. 7 is a flowchart of a process for sharing embedded requests for news inputs on a local network, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for embedding requests for news inputs in web feeds are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term feed or web feed refers to, for example, an RSS (Really Simple Syndication) feed. Although various embodiments are described with respect to RSS feeds and news inputs, it is contemplated that the approach described herein may be used with other web feeds that generally include any of a family of wed feed formats used to publish works that are updated, as well as other content.

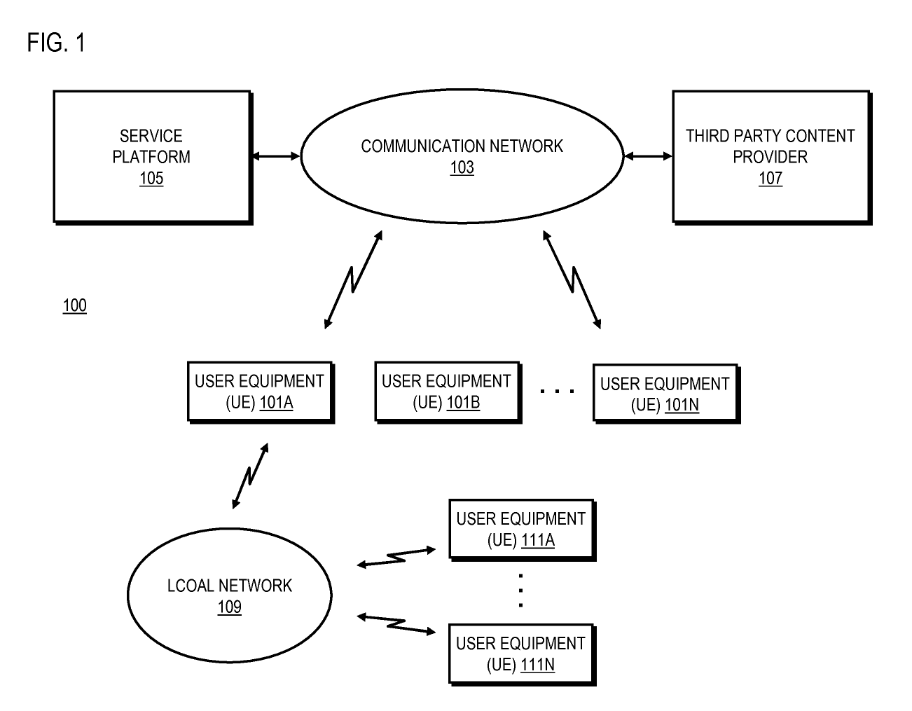

FIG. 1 is a diagram of a system capable of embedding requests for news inputs in web feeds, according to one embodiment. While mobile phone technology has created a potential for the capturing and dissemination of vast amounts of citizen news information, there are significant hurdles for news outlets to effectively collect and filter through the information from such citizen news reporting so that news worthy information can be quickly collected and passed on to their consumers. The hurdles include how to channel requests from the news outlet to specific citizen news journalists (or news input source) in order to ensure the relevance of the news input received from such news input sources.

To address this problem, a system 100 of FIG. 1 introduces the capability to embedding requests for news inputs in web feeds utilizing certain filters. The systems allows for an approach for embedding requests for news inputs in web feeds that can allow for targeting of news input sources.

As shown in FIG. 1, the system 100 comprises user equipment (UE) 101A, 101B, . . . 101N having connectivity to a communication network 103, and via the communication network 103 to a service platform 105. By way of example, the communication network 103 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UEs 101A, 101B, . . . 101N are any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), or any combination thereof. It is also contemplated that the UEs 101A, 101B, . . . 101N can support any type of interface to the user (such as “wearable” circuitry, etc.).

As noted above, the UEs 101A, 101B, . . . 101N can communicate with the service platform 105 via the communication network 103, and can communicate with a content provider 107 (which for example is a third party with respect to the service provider of service platform 105) via the communication network 103 if desired. Alternatively, content provider 107 can be managed by a common service provider with the platform 105. By way of example, the third party content provider 107 can be an RSS feed source, for example, published by a news media outlet. Additionally, the service platform 105 can communicate with the third party content provider 107 via the communication network. Additionally, one or more of the UEs 101A, 101B, . . . 101N can communicate with a local network 109 having local connectivity, and therefore can communicate with one or more UEs 111A . . . 111N that are also in communication with the local network 109.

By way of example, the UEs 101A, 101B, . . . 101N communicate with each other and other components of the communication network 103 using well known, new or still developing protocols. In this context, a protocol includes a set of rules defining how the network nodes within the communication network 103 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

Although the various embodiments are described with respect to news inputs, it is contemplated that these embodiments can be applied to other similarly originated content.

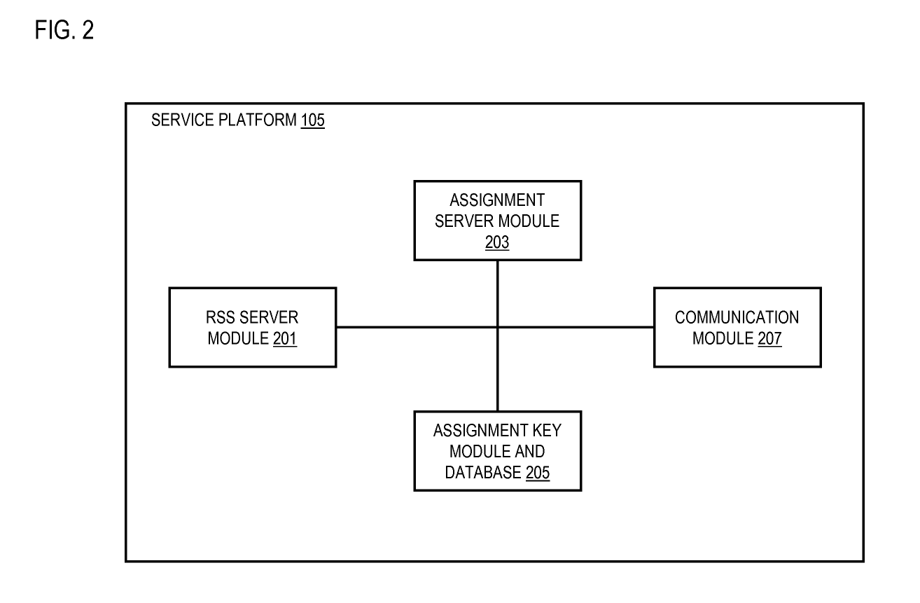

FIG. 2 is a diagram of the components of a service platform that embeds requests for news inputs in web feeds, according to one embodiment. By way of example, the service platform 105 includes one or more components for providing embedded requests for news inputs in web feeds. It is contemplated that the functions of these components may be combined in one or more components or performed by other components of equivalent functionality. In this embodiment, the service platform 105 includes a web feed or RSS server module 201, an assignment server module 203, an assignment key module and database 205, and a communication module 207, which handles communications between the other components of the service platform 105 and the UEs 101A, 101B, . . . 101N, and the third party content provider 107.

By way of example, the service platform 105 can publish RSS feeds with embedded news input requests that can be accessed by certain news input sources, in order to allow news media outlets to place requests to customers (or news input sources) for certain content. For example, an RSS reader on a mobile device side can be connected to a context engine, which tells to a network side server, for example the service platform 105, to perform certain filters in order to determine if any of the requests are suitable for the customer. For example, a journalist in London doing a story on public transport problems could post a request for getting content and comments from customers at selected stations. People reading news feeds in these stations would then receive a request to provide content if their mobile device can provide location verification (e.g., via global positioning system (GPS) or cell based technology). The request would be bound to certain web feeds, which automatically ensure the requests go to only those people that have at least some interest in the topic (e.g., requests having a technology topic go to people reading technology topic feeds) and that are located in the appropriate location (e.g., requests for information about a particular location go to people at that location). Such filters can powerfully ensure there will not be a huge amount spamming for news items to people not interested in citizen journalism, and/or people who are not in a position to provide accurate. credible information on a subject or event.

According to certain embodiments, the news input requests are embedded in a RSS feed, or in a similar channel. A news request is coded in the feed message, containing the metadata describing the contextual information (e.g., targeted location, time, etc.) for the request, and possible authorization related information. The coded metadata can contain information such as where and when particular information is displayed, and to whom it is displayed. For example, a request can be targeted to people who are at the Paddington railway station during afternoon hours. Only those persons who have registered for and opted-in to the service, and that are at the Paddington station during the predefined afternoon hours would see the message/request. Once the person sees the request, then the person can accept the assignment if they so choose or decline/ignore the assignment. It is also possible to target messages to a particular user group, for example, that can be set as a preference by the user when registering for news assignments. The message channel feed can contain non-public information and requests that are only displayed to persons who belong to the particular group, and have a required key pair. For example, a request can be sent to all city workers, or to private hobby club members, who all share the keys.

Keeping profiles of the persons in a centralized database is problematic from privacy point of view. Many people are not willing to disclose their availability, location, expertise, or other information for the purposes of the targeting information requests. There are also risks in storing the personal data in a central place. From business perspective, centralized profile servers are difficult, since it would require a single player to manage the data, or a complex federation model. A benefit of the proposed system, in accordance with certain embodiments, is that the personal profiles and related contextual data would be stored locally in end-users devices that can be tamper-resistant devices, such as smart cards embedded within a mobile device or other computer device. The coded messages in a feed would describe the context information that would be matched by the context engine to the local personal information. If the contextual information matches, and person has authorization for the request, then the request for the information is displayed.

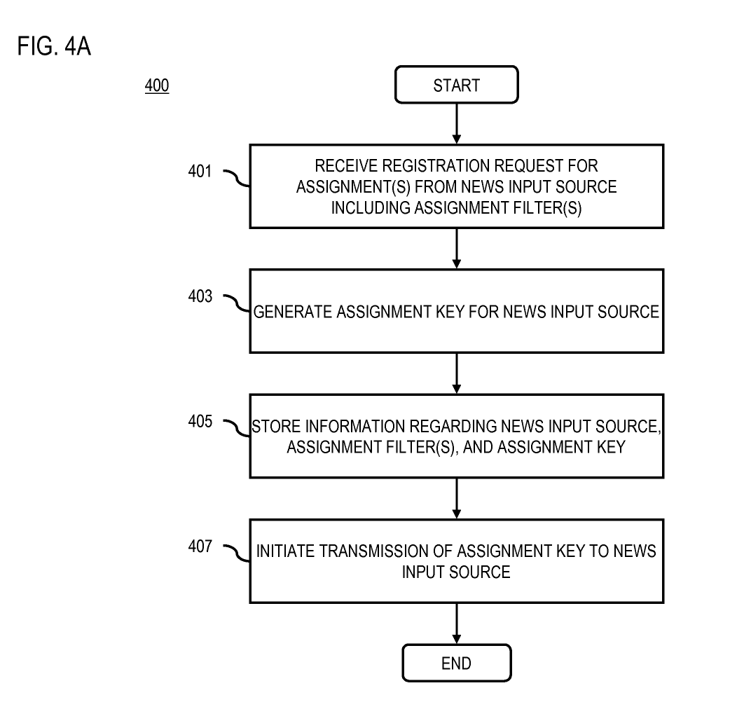

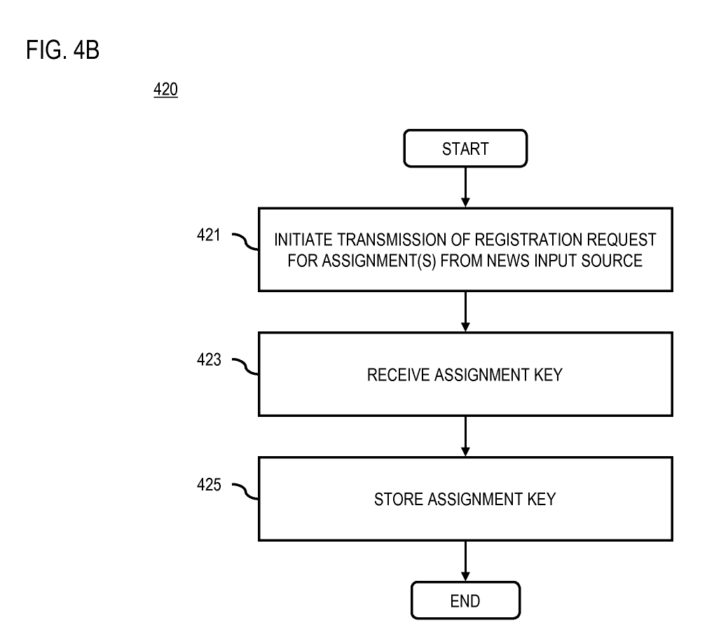

In the embodiment shown in FIG. 2 (see also FIG. 4A and corresponding discussion), the service platform 105 includes an assignment server module 203 that can receive registration requests for assignments from news input sources via the communication module 207. Thus, a customer (i.e., news input source) can register to receive a particular web feed and also set any preferences regarding whether the customer wants to receive news assignments and, if so, whether the customer wants to place any particular filtering restrictions on their registration (e.g., the customer wants to receive news assignments related to technology, sports, art, traffic reports, etc.). The assignment server module 203 can access the assignment key module and database 205 in order to store such registration information of users, and to generate assignment key pairs for that user or user group that can be later used to verify the users' authorization to receive the request for news input. The assignment server module 203 can then forward the assignment key pair to the user via the communication module 207.

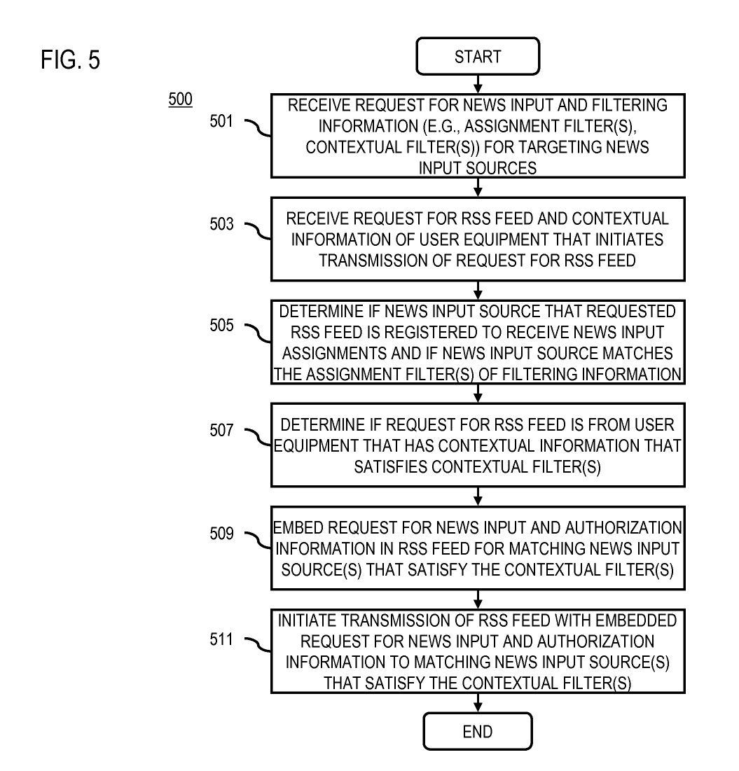

In the embodiment shown in FIG. 2 (see also FIG. 5 and corresponding discussion), the service platform 105 includes a web feed or RSS server module 201 that receives web feeds, as well as request for news input and filtering information from a web feed source, such as, third party content provider 107 via communication module 207. When a device of a user requests the web feed via the communication module 207, the assignment server module 203 can be employed to manage initial filtering of input sources to determine whether the user is registered to receive news input assignments and whether the user's preference profile and contextual information sent with the request from the user's device matches the filtering information provided with the request for news input. The assignment server module 203 can apply the filtering information in order to determine if the user is registered and if the user's request satisfies the filtering information. The assignment server module 203 can access the assignment key module and database 205 in order to retrieve stored registration of users, and to retrieve stored assignment key pairs that can be sent with the web feed to the users in order to verify the users' authorization to receive the request for news input. Once the assignment module 203 determines that the users is registered and the user's request satisfies the filtering information, and the corresponding assignment keys are retrieved from the database 205, then the RSS server module 201 will embed the request and the assignment keys within the published web feed, which the user can access via the communication module 207.

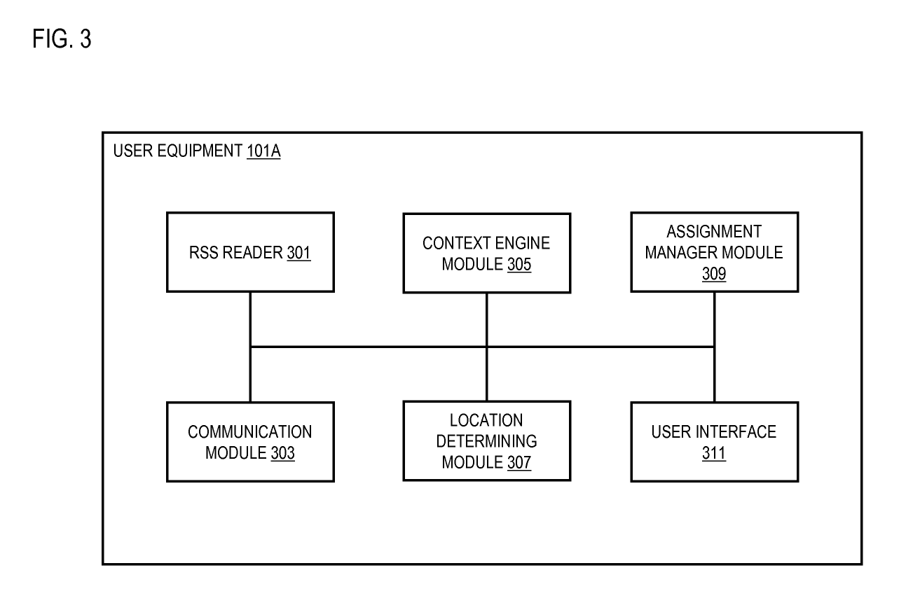

FIG. 3 is a diagram of the components of user equipment that receives embedded requests for news inputs in web feeds, according to one embodiment. By way of example, the user equipment 101A includes one or more components for requesting wed feed, and for receiving and displaying embedded requests for news inputs in web feeds. It is contemplated that the functions of these components may be combined in one or more components or performed by other components of equivalent functionality. In this embodiment, the UE 101A a web feed reader or RSS reader 301, a communication module 303, a context engine module 305, a location determining module 307, an assignment manager module 309, and a user interface 311.

In the embodiment shown in FIG. 3 (see also FIG. 4B and corresponding discussion), the UE 101A includes an assignment manager module 309 that can transmit registration requests for assignments to the assignment server module 203 via the communication module 303. Thus, a customer (i.e., news input source) can register to receive a particular web feed and also set any preferences regarding whether the customer wants to receive news assignments and, if so, whether the customer wants to place any particular filtering restrictions on their registration (e.g., the customer wants to receive news assignments related to technology, sports, art, traffic reports, etc.). The assignment manager module 309 can then receive and store an assignment key pair from the assignment key module and database 205 that can be later used to verify the users' authorization to receive the request for news input.

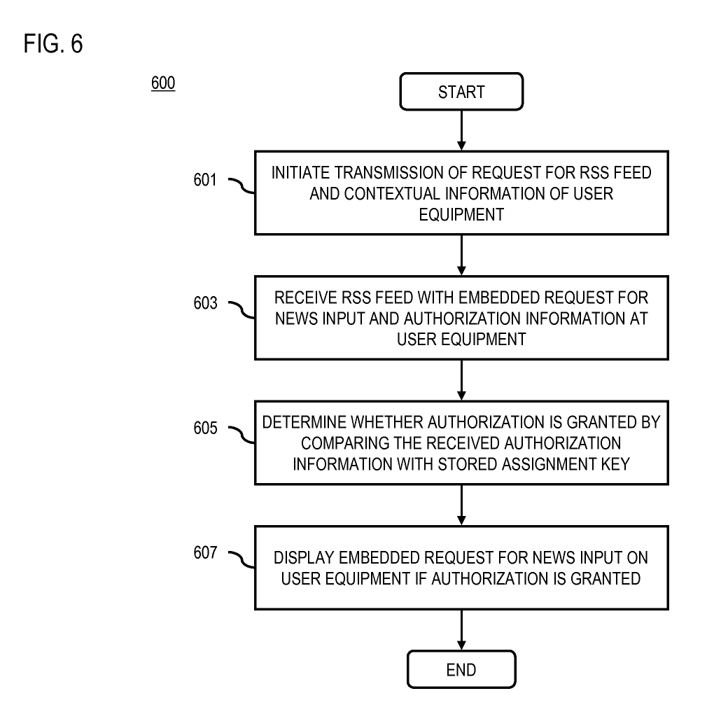

In the embodiment shown in FIG. 3 (see also FIG. 6 and corresponding discussion), the UE 101A includes an RSS reader 301 that has the capability to receive and handle web feeds with embedded requests for news input. When a user wants to send a request for web feed via the communication module 303, the assignment manager module 309 can be employed to compile information that is sent with the request for web feed. For example, the assignment manager module 309 can employ the context engine module 305 to determine contextual information regarding the UE 101A (e.g., current location, time, etc.). For example, the contextual engine module 305 can utilize a location determining module 307 (e.g., GPS device, or cellular location determining technology) to determine the current location of the UE 101A, a time determining module (not shown) to determine current time, etc., and compile such contextual information and forward such contextual information to the assignment manager module 309. Once the contextual information is compiled, then the assignment manager 309 can transmit the contextual information, as well as some user identification information to the service platform 105 along with the request for web feed.

When the UE 101A receives web feeds with embedded requests for news input at the RSS reader 301 from the service platform 105 via the communication module 303, then the assignment manager module 309 determines whether the assignment key embedded in the web feed matches the stored assignment key of the UE 101A to determine authorization to access the embedded request for news input. If authorization is granted, then the user interface 311 can be used to display the request for news input. The user can then utilize the user interface 311 to response to the request for news input, which can be sent via the communication module 303 to the service platform 105, and which can then forward the response to the news input requesting party, such as third party content provider 107. The user interface 311 can include any number and variety of data input and data output devices, for example, a display screen, audio input/output device, camera (e.g., still camera, video camera) input device.

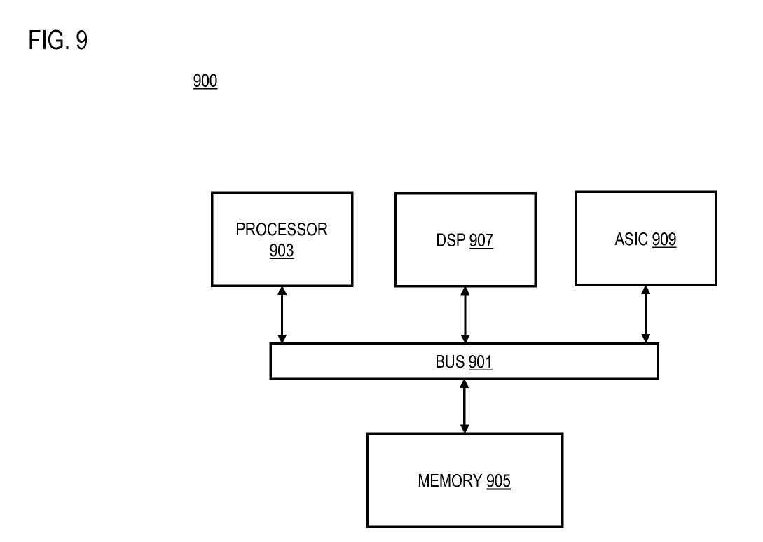

FIG. 4A is a flowchart of a process 400 for registering requests for assignments from a new input source, according to one embodiment. In one embodiment, the components of the service platform 105 performs the process 400 and is implemented in, for instance, a chip set including a processor and a memory as shown FIG. 9. In step 401, the service platform 105 receives a registration request for assignments from a news input source. The registration request can include various assignment filters that the user selects in order to set preferences for the types of assignments the user receives (e.g., selected group(s), subject matter, etc.). In step 403, the service platform 105 generates an assignment key for the news input sources, and the information regarding the news input source, and associated assignments filters and assignment key are stored by the service platform 105 in step 405. In step 407, the service platform 105 initiates transmission of the assignment key to the news input source so that the news input source can store the assignment key for later use.

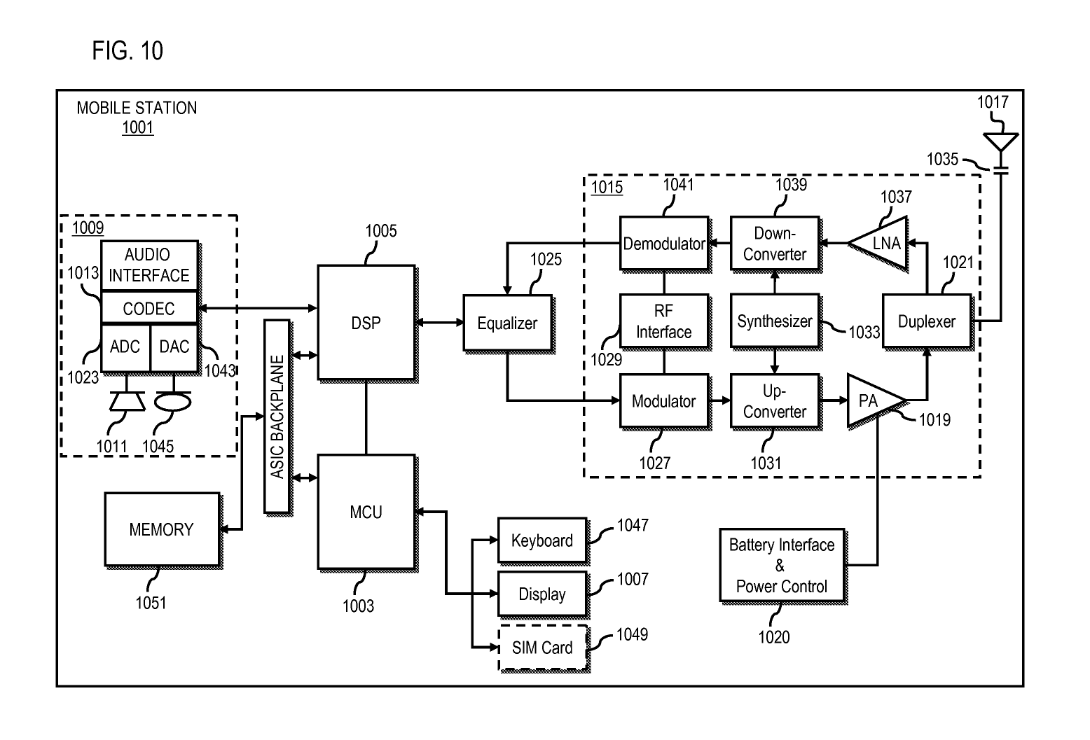

FIG. 4B is a flowchart of a process 420 for requesting registration for assignments from a new input source, according to one embodiment. In one embodiment, the components of the UE 101A performs the process 420 and is implemented in, for instance, components of a mobile station as shown FIG. 10. In step 421, the UE 101A initiates transmission of a registration request for assignments to the service platform 105 from the news input source. As noted above, the registration request can include various assignment filters that the user selects in order to set preferences for the types of assignments the user receives (e.g., selected group(s), subject matter, etc.). In step 423, the UE 101A then receives an assignment key from the service platform 105, and stores the assignment key for later use, in step 425.

FIG. 5 is a flowchart of a process for receiving and embedding requests for news inputs in web feeds, according to one embodiment. In one embodiment, the components of the service platform 105 performs the process 400 and is implemented in, for instance, a chip set including a processor and a memory as shown FIG. 9. In step 501, the service platform 105 receives a request for news input and filtering information, which can include assignment filters (e.g., a particular group filter, subject matter filter, etc., that are indicated as preferences by registered news input sources) and contextual filters (e.g., location, time, etc.) for targeting news input sources. In step 503, the service platform 105 receives from a potential news input source a request for RSS feed and contextual information of user equipment that initiates transmission of the request for RSS feed. Such a request for RSS feed includes identifying information of the potential news input source, which can be in a coded or encrypted format if desired to secure privacy of the source, such that the service platform 105 can locate any stored information (e.g., preferences, assignment keys, etc.) of the potential news input source.

The service platform 105 then performs certain filter steps in order to determine if the RSS feed should be embedded with a request for news input for transmission to the requesting news input source. In step 505, the service platform 105 determines if the news input source that has requested the RSS feed is registered to receive news input assignments. If the news input source is registered, then the service platform 105 also determines if the preferences of the registered news input source matches the assignment filters of the filtering information in the initial request for news input from the media outlet. If the preferences of the registered news input source match the assignment filters, then, in step 507, the service platform 105 determines if the contextual information of the UE, which was provided with the request for RSS feed, satisfies the contextual filters of the filtering information in the initial request for news input from the media outlet.

If the various checks in steps 505 and 507 are met, then, in step 509, the service platform 105 embeds the request for news input and authorization information (e.g., the assignment key of the news input source) in the RSS feed, and, in step 511, the service platform 105 initiates transmission of the RSS feed with the embedded request for news input and authorization information to the news input source.

FIG. 6 is a flowchart of a process for requesting web feeds and receiving embedded requests for news inputs in the web feed, according to one embodiment. In one embodiment, the components of the UE 101A performs the process 420 and is implemented in, for instance, components of a mobile station as shown FIG. 10. In step 601, the UE 101A initiates transmission of a request for RSS feed to the service platform 105. This transmission also includes contextual information regarding the UE 101A, as well as identification information of the new input source that initiated the transmission. In step 603, the UE 101A receives the RSS feed with embedded request for news input and authorization information from the service platform 105. In step 605, the UE 101A determines whether authorization to view the request for news input is granted, by comparing the authorization information with an assignment key pair stored in the UE 101A. Then, in step 607, the embedded request for news input is displayed on the UE 101A if authorization is granted, and the user can then respond to the request in any desired manner, for example, using a camera, keyboard, audio input, or other input device of the UE 101A and transmit such response back to the service platform 105 for relay to the media outlet. The operation of the assignment manager module and RSS reader in the UE 101A can run in the background while other applications of the UE 101A and being used, such that when a request is received, then the user can be notified that such a request has been received and is available for display. Furthermore, it is possible to link the notification to a particular application depending on the request type (e.g., picture requests are notified when the user starts the camera application, etc.).

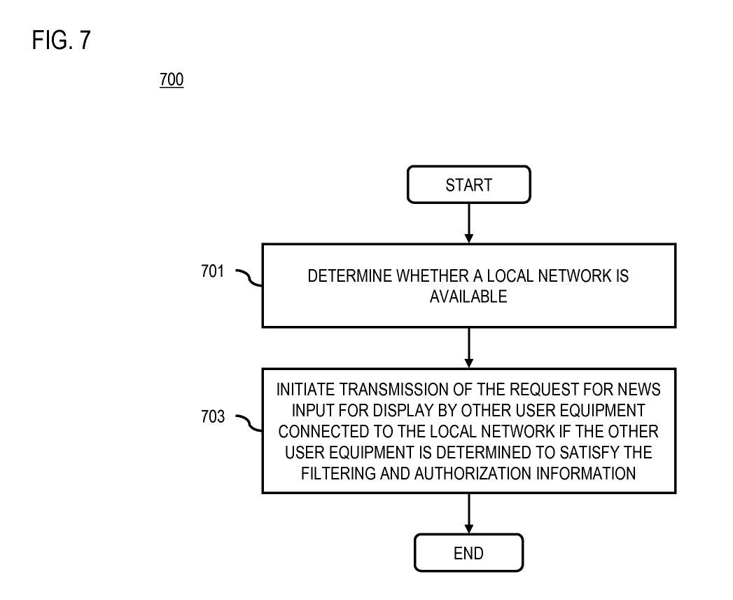

FIG. 7 is a flowchart of a process for sharing embedded requests for news inputs on a local network, according to one embodiment. In one embodiment, the components of the UE 101A performs the process 420 and is implemented in, for instance, components of a mobile station as shown FIG. 10. In this embodiment, a notification system is provided that allows user equipment (e.g., UE 101A) that receives an embedded request for news input to share this request with other user equipment (e.g., UE 111A . . . 111N), for example, via a second communication network (e.g., local network 109 using wireless LAN (WLAN), WiFi, Bluetooth technology, etc.). For example, in a situation when the other user equipment does not have an RSS reader or the RSS reader is inactive, the user equipment that receives the embedded request can share this request with the other user equipment if the other user equipment is available for receiving news input assignments. In such an embodiment, the UE 101A can handle the processing of the request for the UE 111A in the background of the operation of UE 101A, such that the UE 101A acts as a conduit between the service platform 105 and the UE 111A. For example, a phone client can be utilized for assignment handling, in order to share assignments with other requestors in proximity and to manage the assignment keys in background processes (e.g., while the RSS feed reader in the user equipment is closed and there is only local connectivity is active).

In the embodiment of FIG. 7, the UE 101A can determine whether a local network is available in step 701. If such a local network is available, then, in step 703, the UE 101A can initiate transmission of the request for news input to UE 111A, for display by UE 111A connected to the local network if UE 111A is determined to satisfy the filtering and authorization information. In such a case, the UE 101A can pass the necessary filtering information (e.g., contextual information, user identification information, assignment keys, etc.) between the service platform 105 and the UE 111A, for example, by utilizing the assignment manager module 309 operating in the background of the UE 101A.

The processes described herein for providing embedded requests for news inputs in web feeds may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

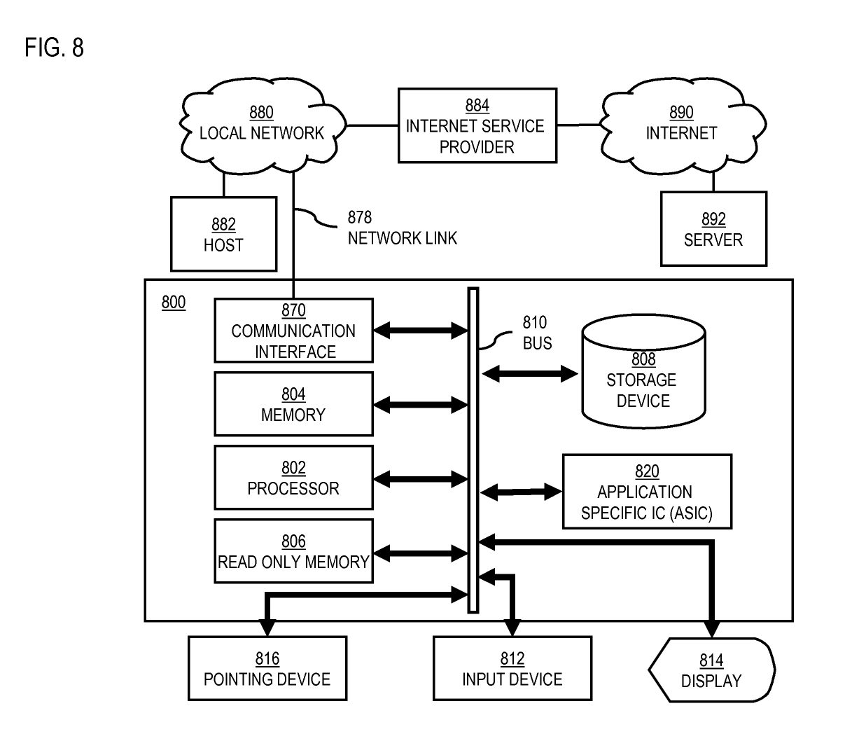

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to embed requests for news inputs in web feeds as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of embedding requests for news inputs in web feeds.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to embedding requests for news inputs in web feeds. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for embedding requests for news inputs in web feeds. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for embedding requests for news inputs in web feeds, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 103 for embedding requests for news inputs in web feeds to the UEs 101A, 101B, . . . 101N.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set 900 upon which an embodiment of the invention may be implemented. Chip set 900 is programmed to embed requests for news inputs in web feeds as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 900, or a portion thereof, constitutes a means for performing one or more steps of embedding requests for news inputs in web feeds.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to embed requests for news inputs in web feeds. The memory 905 also stores the data associated with or generated by the execution of the inventive steps.

FIG. 10 is a diagram of exemplary components of a mobile terminal (e.g., handset) for communications, which is capable of operating in the system of FIG. 1, according to one embodiment. In some embodiments, mobile terminal 1000, or a portion thereof, constitutes a means for performing one or more steps of receiving and displaying embedded requests for news inputs in web feeds. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application, the term “circuitry” would also cover an implementation of merely a processor (or multiple processors) and its (or their) accompanying software/or firmware. The term “circuitry” would also cover, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of receiving and displaying embedding requests for news inputs in web feeds. The display 10 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, worldwide interoperability for microwave access, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to view embedded requests for news inputs in web feeds. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a request for news input in conjunction with a web feed, wherein the request includes filtering information for targeting news input sources; and
causing at least in part transmitting of the web feed with the request for news input embedded in the web feed to a news input source that satisfies the filtering information.

2. A method of claim 1, further comprising:
receiving a request for the web feed and contextual information of user equipment sending the request for the web feed,
wherein the causing at least in part transmitting is performed with respect to the user equipment if the contextual information satisfies the filtering information.

3. A method of claim 1, wherein the embedded request for news input includes an assignment key for verifying authorization of the news input source to respond to the request for news input.

4. A method of claim 1, further comprising:
receiving a registration request for news input assignments from the news input source;
generating an assignment key for the news input source; and
causing at least in part transmitting of the assignment key to the news input source.

5. A method of claim 4, wherein the registration request includes an assignment filter, and wherein the causing at least in part transmitting is performed with respect to the news input source if the assignment filter matches the filtering information of the request for news input.

6. An apparatus comprising:
at least one processor; and
at least one memory including computer program code,
the at least one memory and the computer program code configured to, with the at least one processor, cause the apparatus to perform at least the following:
receive a request for news input in conjunction with a web feed, wherein the request includes filtering information for targeting news input sources; and
cause at least in part transmitting of the web feed with the request for news input embedded in the web feed to a news input source that satisfies the filtering information.

7. An apparatus of claim 6, wherein the apparatus is further caused to:
receive a request for the web feed and contextual information of user equipment sending the request for the web feed,
wherein the causing at least in part transmitting is performed with respect to the user equipment if the contextual information satisfies the filtering information.

8. An apparatus of claim 6, wherein the embedded request for news input includes an assignment key for verifying authorization of the news input source to respond to the request for news input.

9. An apparatus of claim 6, wherein the apparatus is further caused to:
receive a registration request for news input assignments from the news input source;
generate an assignment key for the news input source; and
cause at least in part transmitting of the assignment key to the news input source.

10. An apparatus of claim 9, wherein the registration request includes an assignment filter, and wherein the causing at least in part transmitting is performed with respect to the news input source if the assignment filter matches the filtering information of the request for news input.

11. A method comprising:
causing at least in part transmitting of a request for a web feed; and
receiving the web feed with a request for news input embedded in the web feed if the request for the web feed satisfies filtering information for targeting news input sources, which corresponds to the request for news input.

12. A method of claim 11, wherein the causing at least in part transmitting includes transmitting contextual information of user equipment sending the request for the web feed, and wherein the request for the web feed satisfies the filtering information if the contextual information satisfies the filtering information.

13. A method of claim 11, wherein the embedded request for news input includes an assignment key for verifying authorization of the news input source to respond to the request for news input, said method further comprising:
determining whether authorization is granted by comparing the embedded assignment key to a stored assignment key of the news input source.

14. A method of claim 11, further comprising:
causing at least in part transmitting of a registration request for news input assignments for a news input source; and
receiving an assignment key for the news input source.

15. A method of claim 14, wherein the registration request includes an assignment filter, and wherein the request for the web feed satisfies the filtering information if the assignment filter matches the filtering information of the request for news input.

16. A method of claim 11, further comprising:
causing at least in part transmitting of the request for news input to a device via a local network if the device satisfies the filtering information.

17. An apparatus comprising:
at least one processor; and
at least one memory including computer program code,
the at least one memory and the computer program code configured to, with the at least one processor, cause the apparatus to perform at least the following:
cause at least in part transmitting of a request for a web feed; and
receive the web feed with a request for news input embedded in the web feed if the request for the web feed satisfies filtering information for targeting news input sources, which corresponds to the request for news input.

18. An apparatus of claim 17, wherein the causing at least in part transmitting includes transmitting contextual information of user equipment sending the request for the web feed, and wherein the request for the web feed satisfies the filtering information if the contextual information satisfies the filtering information.

19. An apparatus of claim 17, wherein the embedded request for news input includes an assignment key for verifying authorization of the news input source to respond to the request for news input, and wherein the apparatus is further caused to:
determine whether authorization is granted by comparing the embedded assignment key to a stored assignment key of the news input source.

20. An apparatus of claim 17, wherein the apparatus is further caused to:
cause at least in part transmitting of a registration request for news input assignments for a news input source; and
receive an assignment key for the news input source.

21. An apparatus of claim 20, wherein the registration request includes an assignment filter, and wherein the request for the web feed satisfies the filtering information if the assignment filter matches the filtering information of the request for news input.

22. An apparatus of claim 17, wherein the apparatus is further caused to:
cause at least in part transmitting of the request for news input to a device via a local network if the device satisfies the filtering information.
